(19) United States
(12) Patent Application Publication
(10) Pub. No.: US 2014/0311498 A1
(43) Pub. Date: Oct. 23, 2014

(54) SURGICAL FIXTURE DEVICE HAVING A RAPIDLY EXCHANGEABLE RETAINING PLATE FOR THE PRESSURE ELEMENTS

(71) Applicant: Hubert Noras, Wurzburg (DE)

(72) Inventor: Hubert Noras, Wurzburg (DE)

(21) Appl. No.: 13/979,201

(22) PCT Filed: Jan. 11, 2012
(86) PCT No.: PCT/DE2012/000016

§ 371 Date: Jun. 11, 2014

(30) Foreign Application Priority Data
Jan. 13, 2011 (DE) 10 2011 008 490.8

(51) Int. Cl. A61G 13/12

(52) U.S. Cl. CPC A61G 13/1295; A61G 13/121; A61G 13/1235; A61G 13/1245; A61G 13/123; A61G 13/127
USPC 128/845

(57) ABSTRACT

The invention relates to a surgical fixture device, comprising a C- or U-shaped retaining bracket (2), which extends on a part of the outer circumference from a body part, is spaced apart therefrom and has at least one single pressure element (3) on the end of its first leg (21) and at least two pressure elements (3) on the end of its second leg (22). All pressure elements are pressed against or are partially pressed into the surface of the body part. According to the invention, the pressure elements are fastened to at least one of the two legs by means of in each case one head plate (4) which has at least two threaded bores (5) with in each case an internal thread, a hollow profile (41) which is oriented approximately transversely to the pressure elements being formed into said internal bores. Various types of retaining plates (6) can be slided or plugged into said hollow profile and are provided in each case with at least two threaded holes (5).

The invention relates to a surgical fixture device, comprising a C- or U-shaped retaining bracket, which extends on a part of the outer circumference of a body part, is spaced apart therefrom and bears at least one single pressure element on the end of its first leg and at least two pressure elements on the end of its second leg, all pressure elements being pressed against the surface of the body part.

In operations or other interventions in body parts, such as the head or arm or a leg, or in the case of children, even the torso, it is necessary to firmly clamp the body part to be treated. This position must be retained with great accuracy throughout the entire treatment.

A very interesting exemplary application is skull operations for the removal of brain tumours. Since the surgeon cannot distinguish the affected tissue from healthy tissue with the naked eye, the patient must be transferred into a diagnostic device, such as CT or MRT, during the intervention. By means of this imaging diagnostic device, the region already operated on is checked again to determine whether it is necessary to remove further diseased material. In this diagnostic step, the coordinates of the region that is still to be removed is determined by several key points.

After the body part has been moved out of the diagnostic device, the values determined for the coordinates are the only aids for correctly identifying the regions to be removed.

Therefore, it is of extreme importance that the body part to be treated remains in its position with respect to the surgical fixture device during the process.

In the prior art, retaining brackets are known, which have at their ends bores or threaded bores, into which the pressure elements are screwed. For example, patent U.S. Pat. No. 5,254,079, Agbodoe, describes a retaining bracket for skull operations. At the end of one leg, an eye is formed, into which a thread is cut, into which an internal thread is cut, into which an elongated skull pin with a complementary external thread is screwed. This thread extends over almost the entire length of the skull pin. This results in the disadvantage that an exchange of the skull pin can require a relatively long time for unscrewing the external thread from the internal thread.

At the end of the other leg of the retaining bracket, a small bore is introduced, into which a further smaller auxiliary retaining bracket is screwed. This small auxiliary retaining bracket bears at its two ends a skull pin in each case, which are inclined at a particular angle with respect to one another. If it is necessary for the angle of inclination of the two skull pins to be changed with respect to one another, for example because, instead of the skull of an adult, the head of a child has to be clamped in—the auxiliary retaining bracket must be exchanged.

Disadvantageously, for this purpose the screw connection must be completely released, the screw removed and then the auxiliary retaining bracket exchanged. Then the screw must be centred so that it can be rotated in without damaging the thread. Then, further processing time is necessary for rotating in and tightening the screw. Overall, therefore, a relatively long time is necessary for exchanging a skull pin.

Since, in practice, it is often only after the laying of down the patient and the first adjustment thereof that it can be estimated what type of skull pin is most suitable, a rapid exchange of the skull pin may be necessary. The time consumed for this is very cost intensive in operations in general, since, during the screwing onto the skull pins, the other operation teams must wait, and because the patient must be anaesthetized for such a long time, and the operating theatre is blocked for other uses.

Against this background, it is the object of the invention to develop a connection between pressure elements—such as skull pins—and the retaining brackets that bear it, which permit a very rapid exchange of the pressure elements, even when the patient is already lying thereon.

As a solution, the invention teaches that the pressure elements on at least one of the two legs are fastened by means of a head plate in each case, which has at least two threaded bores with an internal thread in each case, and into which a hollow profile is formed approximately transversely to the pressure elements, into which various types of retaining plates can be slid in or plugged in, into which at least two threaded bores are introduced.

An essential feature of the invention is thus that, for the connection between the retaining bracket and the pressure elements, not a single connecting piece but a universally applicable head plate is fastened on the retaining bracket. By means of the head plate, the skull pins are connected, in which they are fastened on a retaining plate, which—in a very short time and with only a single manual operation—can be slid or plugged into the head plate. It is thus the merit of the invention, through the displacement of the connecting function to two mutually contacting plates, to have created sufficient free space for a quick-release connection.

The hollow profile here, in the most general case, only serves for guiding and centring the retaining plate on the last portion of the approach to the head plate. In an advantageous embodiment, however, the hollow profile can also be developed into a complete connection.

The invention proposes as an advantageous embodiment, an approximately U-shaped hollow profile, into the side walls of which, a depression is introduced in each case, which in the longitudinal direction of the pressure elements, form an undercut. The retaining plate, which fits thereon, has, in cross-section, a profile that is at least partly complementary with the hollow profile, which, with lateral bulges, engages in the depressions of the side walls of the hollow profile. In the normal case, these bulges run through the two side edges of the retaining plate. However, it is also possible to integrally form these bulges, only in sections, onto the side edges of the retaining plate.

Retaining plates with both variants can be inserted into the end faces of the hollow profile, the bulges nestling into the depressions of the side walls of the hollow profile. By this means, the retaining plate is guided on insertion into the head plate and, when it reaches its end position, is secured against falling out, because, seen in the longitudinal direction of the pressure elements, the depressions form an undercut.

To facilitate the introduction of the retaining plate into the hollow profile, the invention proposes bevelling the profile of the retaining plate at both ends, so that it has very great play with respect to the hollow profile at the beginning of the introduction process. By this means, the person introducing it is only required to have a relatively low positioning accuracy at the beginning of the process, which considerably speeds up the process.

Though the “bevelled” sections of the retaining plate can no longer contribute to the retaining of the holding plate in the head plate, this reduction is nevertheless without consequences, since the necessary retaining force is only determined by the intrinsic weight of the retaining plate and the skull pins fastened thereon. In the activation of the skull pins, on the other hand, the retaining plate, with its entire reverse side, is pressed into the base surface of the hollow profile, where it finds a comparatively very large contact surface, so that the transfer of these forces is ensured.

Since it is desirable for the retaining plate, during insertion into the head plate, only to be countered by very small forces, so that the during of the insertion is as low as possible, this “easy” slidability may possibly cause unintended sliding of the retaining plate with respect to the head plate. To prevent this, the invention proposes, in a further embodiment that a resilient detent lug is integrally formed or fastened on both end faces of the retaining plate, which, after complete sliding of the retaining plate into the head plate, lies on one of the two end faces of the head plate in each case. For sliding the retaining plate out of the head plate, one of these two detent lugs must be raised from the head plate, so that it slides through the hollow profile, out of the head plate.

The invention prefers a profile that runs completely through the head plate, so that the holding plate is plugged in at both end faces of the head plate and can also be drawn out again.

However, in principle, a variant is also conceivable in which one end of the hollow profile is closed with a stop for the retaining plate. Then, only a single resilient detent lug would be required, which one have to engage in a complementary depression or onto a bulge projecting out of the head plate. During, removal of the retaining plate out of the head plate, this detent connection can be deactivated again by raising the detent element.

In practice, it is desirable that the surface of the body part to be fixed can have various inclinations with respect to the end point of the retaining bracket. From this, there follows the wish that the head plate should be pivotable in two directions with respect to the retaining bracket. To achieve this freedom of adjustment, the invention proposes that the head plate has a hemispherical recess, which can be placed on a ball head and can be fixed thereon in an optional angular position.

For fixing, for example, a screw is suitable, which runs through the hemispherical recess and through the ball head. For this purpose an opening, which is considerably larger than the cross-section of the screw, is necessary in one of the two elements “ball head” or “hemispherical recess”. In the other component, which is complementary thereto, the opening must be only just large enough for the screw to be plugged completely through it.

Instead of the screw, a bolt can also be used, which has a radially projecting head at its one end and at the other end is connected to a lever construction that is supported on a part of the retaining bracket. It is then possible to rapidly loosen the connection between the ball head and ball segment, to pivot the head plate into the desired angle, specifically both in a horizontal and in a vertical direction and subsequently to clamp it firmly with a handle.

If particularly high forces act between the head plate and retaining bracket or particularly high force impulses must be possible, the invention proposes that ribs, beads or nubs are formed on the ball head, which engage in complementary depressions in the hemispherical recess of the retaining plate. If these elements are disposed in a uniform grid, a stepwise pivoting of the head plate with respect to the retaining bracket is possible.

With uniformly extending ribs, a pivoting in a tangential direction with respect to the ribs is also still possible in a continuously adjustable manner.

In another embodiment, the retaining plate does not have a profile that is complementary to the hollow profile of the head plate, but at least one pin which can be plugged into and/or engaged in a complementary bore in the head plate. In this case, the hollow profile does not have depressions in its side walls but only uses its side walls to centre the retaining plate during introduction into the head plate and secure it again sliding off sideways.

It is a further feature of the head plate according to the invention that it can alternatively serve for fastening pressure elements even without a retaining plate. To this end it has two threaded bores having an internal thread in each case into which a pressure element can be screwed. If the length of this screw flight is relatively short, the time required for insertion and exchange is nevertheless relatively short. It is particularly advantageous if this threaded bore is accessible from the reverse side, so that the pressure element can be guided from the reverse side of the head plate onto the body part.

This variant is in particular appropriate for the relatively very narrow skull pins, since they have a conical tip as pressure element, which presses into the surface of the body part—that is to say, for example, into the skull top of the head The advantage of such a pin is the very good fixing, which remains stable through the duration of the entire operation and the comparatively low, only pointwise injury of the skin. In some cases, they can even be lower than with a pad contacting over a large area, which, during longer operations provides for crushing of the blood vessels of the skin, and thereby can contribute to dying off of the skin part on which it bears.

Further details and features of the invention are explained below in greater detail with reference to an example. This is not intended to restrict the invention, but only to explain it. In diagrammatic view,

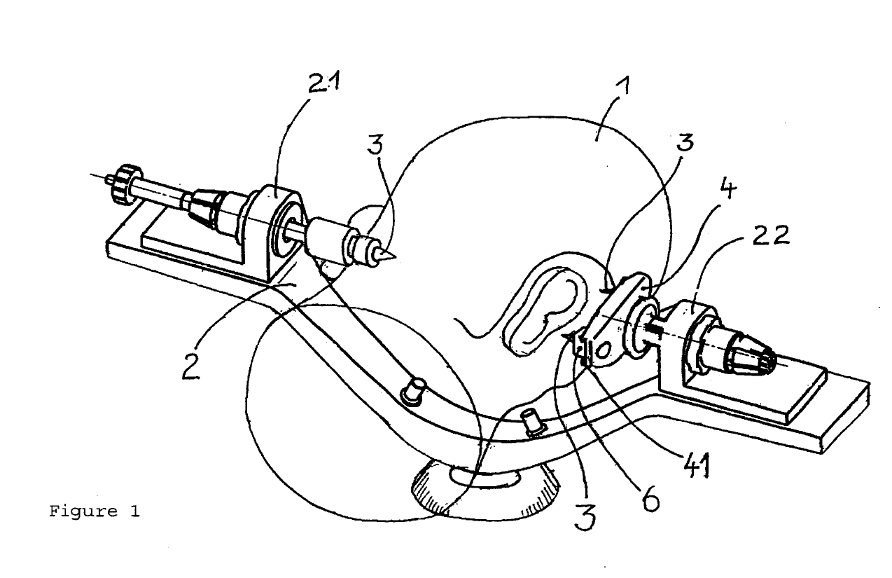

FIG. 1 shows an oblique view of a surgical fixture device for a skull

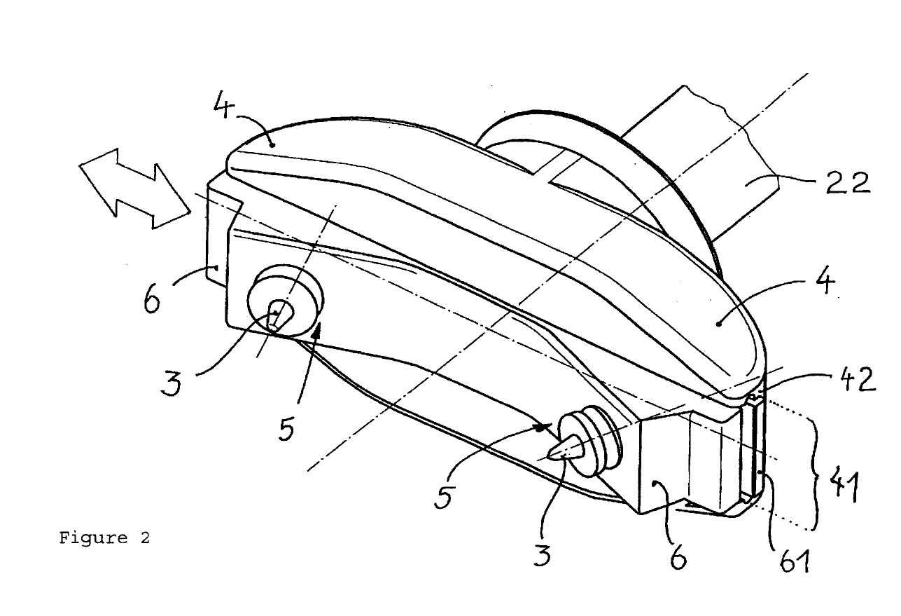

FIG. 2 shows an oblique view of a head plate with inserted retaining plate

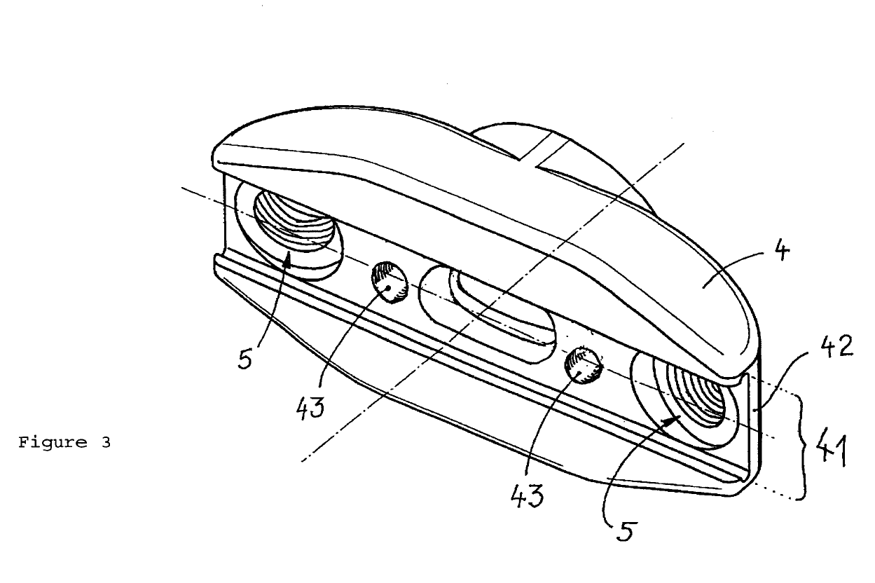

FIG. 3 shows a head plate as FIG. 2, but without a retaining plate

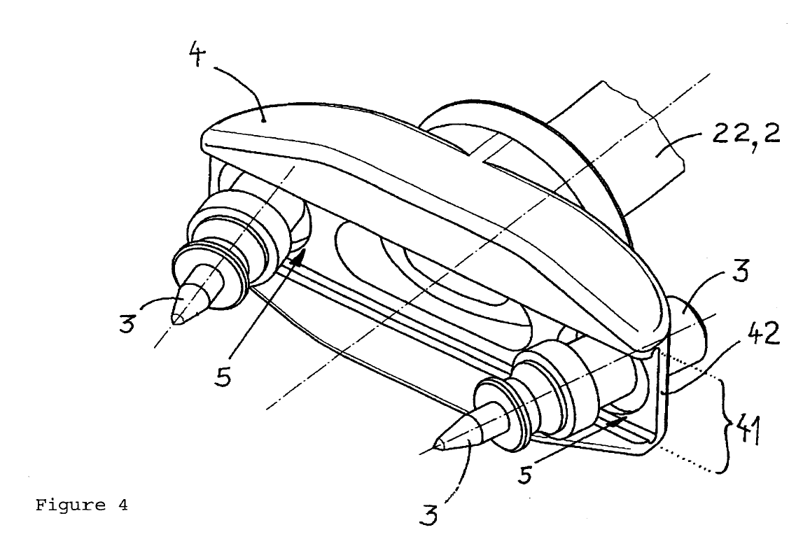

FIG. 4 shows a head plate in a similar way to FIG. 3 with screwed in pressure elements

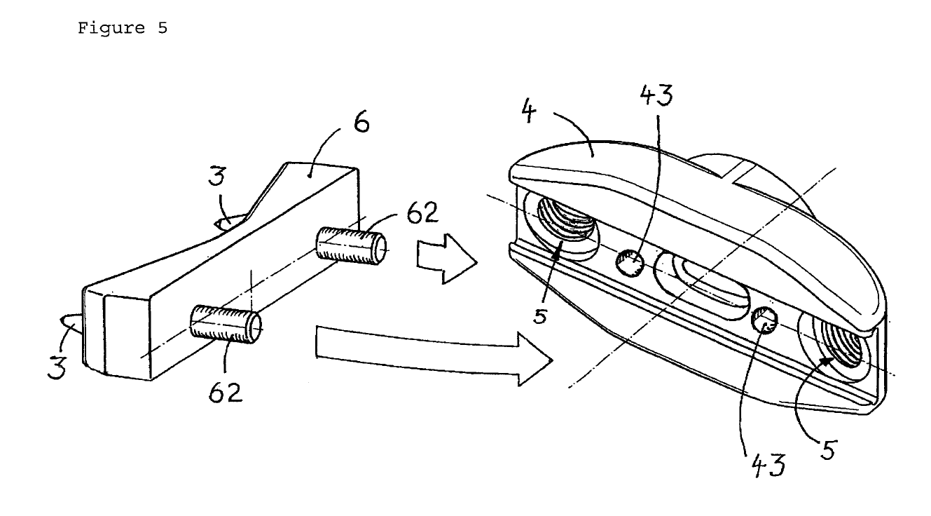

FIG. 5 shows a retaining plate with pins and a head plate 4 that is complementary thereto

In the following description, the same reference character 1 is used in each case both for the body part 1 and for the skull 1, as one of many other examples of a body part 1. Likewise, the skull pin 3 is also provided with the reference character 3, although it is only one of many embodiments of a pressure element 3.

In FIG. 1, as body part 1, a skull 1 is drawn, which is clamped into a retaining bracket 2 for a skull operation.

For better recognition of the retaining bracket 2 and the pressure element 3 that penetrates into the skull 1 at the left-hand side, the skull 1 is shown transparent in FIG. 1. By this means it is clearly recognisable that, at its left-hand side, it is held by a single pressure element 3—in this case a skull pin 3—and, at its right-hand side, by two skull pins 3. While the skull pin 3, which is shown at the left, is retained by a method known in the prior art directly in a fixture on the first leg 21 of the retaining bracket 2—here even with a force measuring device between the skull pin 3 and the first leg 21—on the right-hand side, the two skull pins 3 are held by a retaining plate 6 according to the invention. This retaining plate 6 is inserted laterally into the hollow profile 41 of the head plate 4. The head plate 4 is fastened via a bolt on the second leg 22 of the retaining bracket 2.

In FIG. 1, it is immediately clear that only a slight loosening of the pressure of the head plate 4 on the skull 1 is necessary in order to draw the holding plate 6 out of the hollow profile 41 in the head plate 4. The movement of the retaining plate 6 necessary for this, with the skull pins 3 fixed thereon takes place in the longitudinal direction of the skull 1, for which sufficient space is available, as is immediately clear in FIG. 1.

FIG. 2 shows a head plate 4 according to the invention from the side, which is not shown in FIG. 1, which faces the skull 1. It can be very readily recognized that a retaining plate 6 is inserted into the head plate 4, which is equipped with two skull pins 3. In FIG. 1 the two threaded bores 5, which are introduced into the retaining plate 6 in order to screw in the skull pins 3, are indicated by a thin arrow in each case.

At the right-hand side of the head plate 4, the hollow profile 41 with its two—in this case approximately semicircular—depressions can be seen in its two opposing side walls. In FIG. 2, it is very readily understandable how the retaining plate 6 are grasped in these depressions at their sides, and, therein, can be displaced transversely to the longitudinal axis of the two skull pins 3. This displacement movement is shown at the left-hand side of FIG. 2 by a large double arrow.

At the right-hand side of FIG. 2, the detent lug 61 can be seen at the end face of the retaining plate 6. In FIG. 2, it is very readily visible how this detent lug 61 lies at its angled end region on the end face 42 of the head plate 4. By this means, this end region blocks a movement of the retaining plate 6 to the left. Since, at the other end face of the retaining plate, there is also disposed a detent lug 61—which is not visible in FIG. 2, an—unintended—displacement of the retaining plate 6 to the right is blocked.

In FIG. 3, a head plate 4 according to the invention is illustrated as an individual part. It can be very readily recognized therein how the hollow profile 41 runs uniformly through the entire head plate 4. It is also clear that the hollow profile 41 in this embodiment is U-shaped and a trough-shaped depression is embossed in the two opposite side walls of the U. In FIG. 3, too, it can be readily understood that, at the two edges of a retaining plate 6—which is not shown here, a corresponding bead-shaped counterpart can be slid into this trough-shaped depression.

On the base surface of the U-shaped hollow profile 41, an opening is disposed in the centre, through which a fastening bolt is pushed for connecting the head plate 4 to a leg 21, 22 of the retaining bracket 4. Connecting with this, a bore 43 in each case is disposed on both sides. In another embodiment of a retaining plate 6 according to the invention, they serve to receive pins 62, which are connected to the retaining plate 6. Right at the outer edge of the hollow profile 41, two relatively large threaded bores 5 can be seen. In a further embodiment, a skull pin 3 in each case can be screwed into these threaded bores 5, and is then connected directly to the head plate 4 without the interposition of a retaining plate 6.

FIG. 4 shows a slightly different variant of a head plate 4 according to the invention. In the centre, it only has a relatively large elongated hole to receive the bolat for the connected to the retaining bracket 2. In this variant, the two bores 43 are missing. Instead, the centre opening is somewhat larger. In FIG. 4, it is comprehensible that, alternatively at the ends of the elongated hole shown here, two pins 62 in each case—which are not shown here—of a retaining plate 6 can also be plugged in, which then are only in contact with the elongated hole at a portion of their circumference.

FIG. 4 shows very clearly that a relatively large skull pin 3 is screwed into the two threaded bores 5 at the two ends of the head plate 4. Both threaded bores 5 are slightly inclined with respect to one another, so that the two skull pins 3, which are screwed therein, also run inclined slightly with respect to one another. In FIG. 4, the hollow profile 41 at the right-hand side is marked by a brace, but, however, is not used in this variant.

FIG. 5 shows a further variant for use of a head plate 4, the variant of the head plate 4 shown here corresponding precisely to FIG. 3.

FIG. 5 shows a further version of a retaining plate 6 that is compatible with the illustrated head plate 4. On the front side thereof, which is shown at the left, two skull pins 3 are fastened. At the reverse side facing the viewer, two pins 62 are integrally formed.

In FIG. 5, it is indicated with a short and a long double arrow how, in order to fasten the illustrated embodiment of the retaining plate 6 in the head plate 4, the two pins 62 are introduced into a bore 43 in the head plate 4 on the base of the hollow profile 41, and become wedged there. In FIG. 5, it is clear that, in this embodiment the two threaded bores 5 remain unused.

### List of Reference Characters

1 Body part, e.g. skull
2 Retaining bracket, surrounds body part 1, bears head plates 4
21 First leg of the retaining bracket 2
22 Second leg of the retaining bracket 2
3 Pressure element, e.g. skull pin, presses on the body part 1
4 Head plate, fastened on retaining bracket 2
41 Hollow profile in head plate 4
42 End faces of the head plate 4
43 Bores in head plate 4 for pins 62
5 Threaded bore in head plate 4 or in retaining plate 6
6 Retaining plate, mounted on head plate 4
61 Detent lugs on the end faces of the retaining plate 6
62 Pins on retaining plate 6, can be plugged into bores 43

1. Surgical fixture device, comprising a C- or U-shaped retaining bracket 2,
which extends on a part of the outer circumference of a body part 1, and
is spaced apart from the body part 1 and
bears at least one single pressure element 3 on the end of its first leg 21 and
at least two pressure elements 3 on the end of its second leg 22 and all pressure elements 3 being pressed onto the surface of the body part 1 or partly into the surface,
characterised in that
the pressure elements 3 are fastened to at least one of the two legs 21, 22 by means of a head plate 4 in each case,
which has at least two threaded bores 5 having an internal thread in each case and
into which a hollow profile 41 is formed approximately transversely to the pressure elements 3, into which various types of retaining plate 6 can be slid in or plugged in, into which at least two threaded bores 5 are introduced.

2. Surgical fixture device according to claim 1, characterised in that the body part is
the head or
an arm or
a leg or
the pelvis.

3. Surgical fixture device according to one of the preceding claims, characterised in that the pressure element 3 is
a skull pin or
a pressure plate or
a pressure pad, such as a gel pad.

4. Surgical fixture device according to one of the preceding claims, characterised in that the hollow profile 41 is approximately U-shaped and its side walls have a depression in each case, which, in the longitudinal direction of the pressure elements 3, form an undercut.

5. Surgical fixture device according to claim 4, characterised in that the retaining plate 6, has in cross-section a profile that is at least partly complementary to the hollow profile 41, with bulges which are at least partly continuous and engage in the depressions of the side walls of the hollow profile 41.

6. Surgical fixture device according to claim 5, characterised in that the retaining plate 6 has at its two end faces resilient detent lugs 61, which, after complete sliding in of the retaining plate 6 into the head plate 4, lie against the end faces 42 thereof.

7. Surgical fixture device according to one of the preceding claims, characterised in that the retaining plate 6 has at least one pin, which can be plugged into and/or engaged in a bore in the head plate 4 that is complementary thereto.

8. Surgical fixture device according to one of the preceding claims, characterised in that the retaining plate 6 has a hemispherical recess, which can be fixed on a ball head in an optional angular position.

9. Surgical fixture device according to claim 8, characterised in that the ball head comprises
ribs or
beads or
nubs,
which engage in complementary depressions in the recess of the retaining plate 6.
